(19) United States
(12) Patent Application Publication
(10) Pub. No.: US 2024/0279038 A1
(43) Pub. Date: Aug. 22, 2024

(54) EXPANDABLE PALLET JACK DEVICE

(71) Applicant: Larry Kneuven, II, Buckner, MO (US)

(72) Inventor: Larry Kneuven, II, Buckner, MO (US)

(21) Appl. No.: 18/443,559

(22) Filed: Feb. 16, 2024

Related U.S. Application Data
(60) Provisional application No. 63/447,087, filed on Feb. 21, 2023.

(51) Int. Cl. B66F 9/14; B66F 9/065

(52) U.S. Cl. CPC B66F 9/143; B66F 9/065

(57) ABSTRACT

An expandable pallet jack device is provided. The device is comprised of a frame with two adjustable forks that can move along the frame to accommodate pallets and items of various sizes. Each fork has a textured top surface to prevent slipping and wheels for easy mobility. The device's width and height can be adjusted using arms, which may operate through manual pumping or electronic buttons. Additionally, rear walls attached to the forks can be spaced apart with an adjustable connecting member for added support, enhancing the device's adaptability for transporting a wide size of items.

### CROSS-REFERENCE TO RELATED APPLICATION

The present application claims priority to, and the benefit of, U.S. Provisional Application No. 63/447,087, which was filed on Feb. 21, 2023, and is incorporated herein by reference in its entirety.

### FIELD OF THE INVENTION

The present invention relates generally to the field of pallet jacks. More specifically, the present invention relates to an expandable pallet jack device that provides a pallet jack with adjustable width and height such that the device can be optimally sized and configured to receive any size of pallet and/or item. Accordingly, the present disclosure makes specific reference thereto. Nonetheless, it is to be appreciated that aspects of the present invention are also equally applicable to other like applications, devices, and methods of manufacture.

### BACKGROUND

Existing pallet jack devices often face limitations when it comes to accommodating pallets of different sizes. More specifically, pallet jacks are typically designed with a one-size-fits-all approach, which can lead to inefficiencies and operational challenges in environments where pallet dimensions vary widely. As businesses strive to optimize their logistics and storage capacities, the need for more adaptable pallet jacks becomes increasingly apparent. Without the ability to adjust to the diverse sizes of pallets, companies may encounter difficulties in handling, transporting, and storing goods effectively. This limitation not only affects the speed and fluidity of warehouse operations but also raises concerns about the safety and integrity of goods during movement.

Therefore, there exists a long-felt need in the art for an improved pallet jack. There also exists a long-felt need in the art for an expandable pallet jack device. Further, there exists a long-felt need in the art for an expandable pallet jack device that can expand in width to accommodate pallets of various dimensions and configurations. In addition, there exists a long-felt need in the art for an expandable pallet jack device that can expand in height to accommodate pallets of various dimensions and configurations.

The subject matter disclosed and claimed herein, in one embodiment thereof, comprises an expandable pallet jack device. The device is comprised of a frame with two adjustable forks that can move along the frame to accommodate pallets and items of various sizes. Each fork has a textured top surface to prevent slipping and wheels for easy mobility. The device's width and height can be adjusted using arms, which may operate through manual pumping or electronic buttons. Additionally, rear walls attached to the forks can be spaced apart with an adjustable connecting member for added support, enhancing the device's adaptability for transporting a wide size of items.

In this manner, the expandable pallet jack device of the present invention accomplishes all the forgoing objectives and provides an improved pallet jack. More specifically, the device can expand in width to accommodate pallets of various dimensions and configurations. In addition, the device can expand in height to accommodate pallets of various dimensions and configurations.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an expandable pallet jack device. The device is comprised of a frame comprised of a first fork with a first rear wall and a second fork with a second rear wall. The forks and/or walls can be spaced apart during use via at least one arm to allow the device to expand or contract in size (i.e., height and width) to accommodate various items, pallet sizes, etc. for transport.

The frame is preferably a horizontal frame member comprised of a first fork and a second fork, wherein both forks slide over the frame such that they can be slid along the frame during use to expand the width of the device for accommodating items (such as but not limited to pallets) of various widths/sizes. The top surface of each fork is preferably comprised of at least one texture that prevents items resting on the top surface from slipping/shifting while being transported via the device. Each fork may also be comprised of at least one wheel to allow the forks to be rolled over a surface while moving the device.

In one embodiment, the distance between each fork can be increased or decreased (to increase or decrease the overall width of the device) via at least one arm. This allows the overall width of the device to increase or decrease to accommodate items of various dimensions. The arm may be any type such as but not limited to a hydraulic arm, an electronic arm, a motored arm, etc. In this embodiment, the arm can be increased/decreased in length to increase or decrease the distance between the forks. This can be done via at least one handle and/or at least one foot lever that can be pumped and/or released.

In a further embodiment, each fork is comprised of at least one rear wall that attaches to the fork via at least one arm. The distance between each fork and wall can be increased or decreased (to increase or decrease the overall height of the device) via at least one arm. This allows the overall height of the device to increase or decrease to accommodate items of various dimensions. The arm may be any type such as but not limited to a hydraulic arm, an electronic arm, a motored arm, etc. In this embodiment, the arm can be increased/decreased in length to increase or decrease the distance between the forks via at least one handle and/or at least one foot lever that can be pumped and/or released.

The present invention is also comprised of a method of using the device. First, a device is provided comprised of a frame, a first fork that attaches over the frame, a second fork that attaches over the frame, a first rear wall that attaches to the first fork, and a second rear wall that attaches to the second fork. Then, the distance between the forks can be increased or decreased via at least one arm. Next, the distance between each fork and each rear wall can be increased or decreased via at least one arm. Then, a pallet (or other item) can be placed on the forks and can be supported by the rear walls while the device is used to transport the pallet along a surface.

Accordingly, the expandable pallet jack device of the present invention is particularly advantageous as it provides an improved pallet jack. More specifically, the device can expand in width to accommodate pallets of various dimensions and configurations. In addition, the device can expand in height to accommodate pallets of various dimensions and configurations. In this manner, the expandable pallet jack device overcomes the limitations of existing pallet jacks known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of an expandable pallet jack device of the present invention in accordance with the disclosed architecture;

FIG. 2 illustrates a rear perspective view of one potential embodiment of an expandable pallet jack device of the present invention in accordance with the disclosed architecture;

FIG. 3 illustrates a rear perspective view of one potential embodiment of an expandable pallet jack device of the present invention while extending in accordance with the disclosed architecture;

FIG. 4 illustrates a rear perspective view of one potential embodiment of an expandable pallet jack device of the present invention while extending in accordance with the disclosed architecture;

FIG. 5 illustrates a rear perspective view of one potential embodiment of an expandable pallet jack device of the present invention while extending in accordance with the disclosed architecture; and

FIG. 6 illustrates a flowchart of a method of using one potential embodiment of an expandable pallet jack device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved pallet jack. There also exists a long-felt need in the art for an expandable pallet jack device. Further, there exists a long-felt need in the art for an expandable pallet jack device that can expand in width to accommodate pallets of various dimensions and configurations. In addition, there exists a long-felt need in the art for an expandable pallet jack device that can expand in height to accommodate pallets of various dimensions and configurations

The present invention, in one exemplary embodiment, is comprised of an expandable pallet jack device. The device is comprised of a frame comprised of a first fork with a first rear wall and a second fork with a second rear wall. The forks and/or walls can be spaced apart during use via at least one arm to allow the device to expand or contract in size (i.e., height and width) to accommodate various items, pallet sizes, etc. for transport.

The frame is preferably a horizontal frame member comprised of a first fork and a second fork. Both forks slide over the frame such that they can be slid along the frame during use to expand the width of the device for accommodating items (such as but not limited to pallets) of various widths/sizes. The top surface of each fork is preferably comprised of at least one texture that prevents items resting on the top surface from slipping/shifting while being transported via the device. Each fork may also be comprised of at least one wheel to allow the forks to be rolled over a surface while moving the device.

In one embodiment, the distance between each fork can be increased or decreased (to increase or decrease the overall width of the device) via at least one arm. This allows the overall width of the device to increase or decrease to accommodate items of various dimensions. The arm may be any type such as but not limited to a hydraulic arm, an electronic arm, a motored arm, etc. In this embodiment, the arm can be increased/decreased in length to increase or decrease the distance between the forks. This can be done via at least one handle and/or at least one foot lever that can be pumped and/or released.

In a further embodiment, each fork is comprised of at least one rear wall that attaches to the fork via at least one arm. The distance between each fork and wall can be increased or decreased (to increase or decrease the overall height of the device) via at least one arm. This allows the overall height of the device to increase or decrease to accommodate items of various dimensions. The arm may be any type such as but not limited to a hydraulic arm, an electronic arm, a motored arm, etc. In this embodiment, the arm can be increased/decreased in length to increase or decrease the distance between the forks via at least one handle and/or at least one foot lever that can be pumped and/or released.

The present invention is also comprised of a method of using the device. First, a device is provided comprised of a frame, a first fork that attaches over the frame, a second fork that attaches over the frame, a first rear wall that attaches to the first fork, and a second rear wall that attaches to the second fork. Then, the distance between the forks can be increased or decreased via at least one arm. Next, the distance between each fork and each rear wall can be increased or decreased via at least one arm. Then, a pallet (or other item) can be placed on the forks and can be supported by the rear walls while the device is used to transport the pallet along a surface.

Accordingly, the expandable pallet jack device of the present invention is particularly advantageous as it provides an improved pallet jack. More specifically, the device can expand in width to accommodate pallets of various dimensions and configurations. In addition, the device can expand in height to accommodate pallets of various dimensions and configurations. In this manner, the expandable pallet jack device overcomes the limitations of existing pallet jacks known in the art.

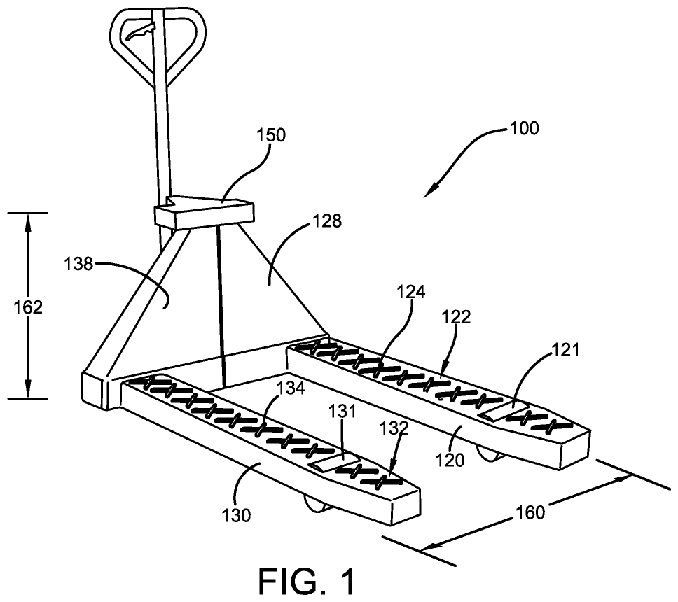

Referring initially to the drawings, FIG. 1 illustrates a front perspective view of one potential embodiment of an expandable pallet jack device 100 of the present invention in accordance with the disclosed architecture. The device 100 is comprised of a frame 110 comprised of a first fork 120 with a first rear wall 128 and a second fork 130 with a second rear wall 138. The forks 120 and/or walls 128,138 can be spaced apart during use via at least one arm 140 to allow the device 100 to expand or contract in size (i.e., height and width) to accommodate various items, pallet sizes, etc. for transport. In one embodiment, the forks 120,130 may be extendable and retractable in length to allow for further optimization. The forks 120,130 may be extended or retracted by arms 140 (as described below) or any other mechanism. All or some components of the device 100 may be comprised of carbon fiber to reduce the total weight of the device 100. The device 100 may also be comprised of a metal material.

The frame 110 is preferably a horizontal frame member. The frame 110 is comprised of a first fork 120 and a second fork 130. Both forks 120,130 attach to and slide along the frame 110 such that they can be slid along the frame 110 during use to expand the width of the device 100 for accommodating items (such as but not limited to pallets) of various widths/sizes. The top surface 122,132 of each fork 120,130 is preferably comprised of at least one texture 124,134. The texture 124,134 is preferably a raised texture that may be arranged in any pattern, such as but not limited to an X-shaped pattern. The texture prevents items resting on the top surface 122 from slipping/shifting while being transported via the device 100. Each fork 120,130 may also be comprised of at least one wheel 121,131 to allow the forks 120,130 to be rolled over a surface while moving the device 100. The wheel 121,131 can be retracted out of and/or in to each fork 120,130 during use via manual or powered (i.e., motorized) means in order to raise the forks 120,130 during use for easier operation.

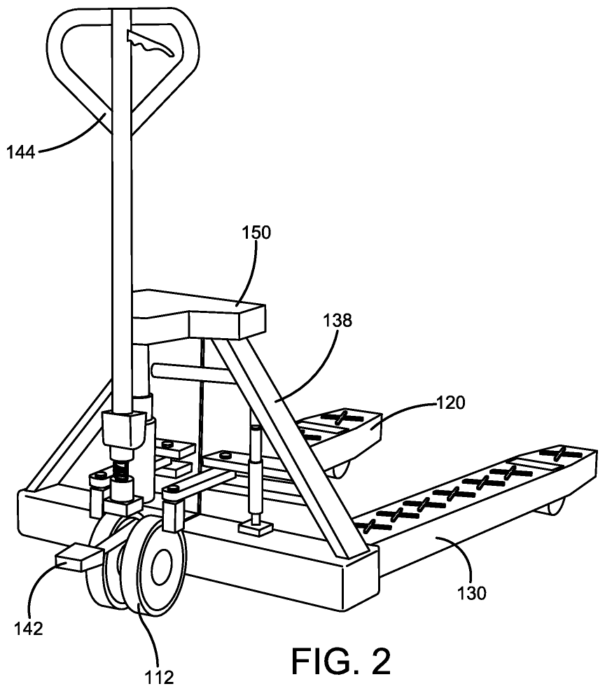

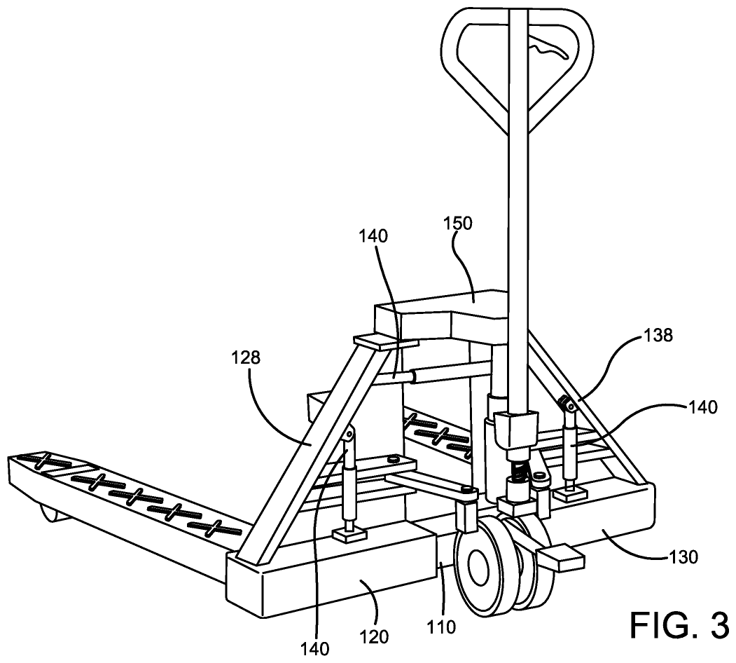

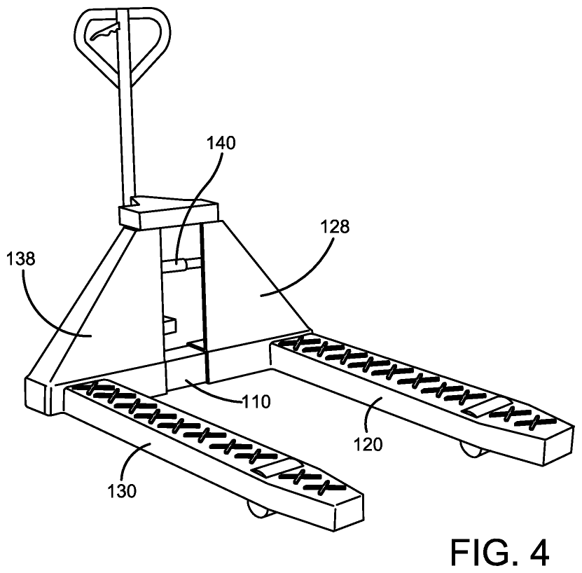

In one embodiment, the distance between each fork 120,130 can be increased or decreased (to increase or decrease the overall width 160 of the device 100) via at least one arm 140. This allows the overall width 160 of the device 100 to increase or decrease to accommodate items of various dimensions, as seen in FIG. 3 and FIG. 4. The arm 140 may be any type such as but not limited to a hydraulic arm, an electronic arm, a motored arm, etc. In this embodiment, the arm 140 can be increased/decreased in length to increase or decrease the distance between the forks 120,130. This can be done via at least one handle 144 and/or at least one foot lever 142 that can be pumped and/or released, as seen in FIG. 2. In another embodiment, the arm 140 is an electronic or motorized arm that can be increased/decreased in length via at least one button 141. It should be noted that the arm 140 may be positioned anywhere on the device 100 to allow the device 100 to be operated in the manner described herein. The arm 140 may further be positioned in any arrangement, orientation, configuration, etc. 100 to allow the device 100 to be operated in the manner described herein.

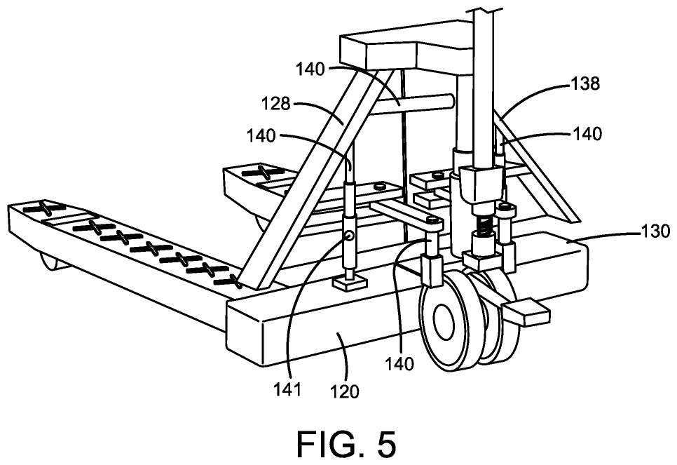

In a further embodiment, each fork 120,130 is comprised of at least one rear wall 128,138 that attaches to the fork 120,130 via at least one arm 140. The distance between each fork 120,130 and wall 128,138 can be increased or decreased (to increase or decrease the overall height 162 of the device 100) via at least one arm 140. This allows the overall height 162 of the device 100 to increase or decrease to accommodate items of various dimensions, as seen in FIG. 5. The arm 140 may be any type such as but not limited to a hydraulic arm, an electronic arm, a motored-arm, etc. In this embodiment, the arm 140 can be increased/decreased in length to increase or decrease the distance between the forks 120,130 via at least one handle 144 and/or at least one foot lever 142 that can be pumped and/or released. The lever 142 may be positioned anywhere on the device 100 but is preferably positioned on either side of the handle 144. In another embodiment, the arm 140 is an electronic or motorized arm that can be increased/decreased in length via at least one button 141. It should be noted that the arm 140 may be positioned anywhere on the device 100 to allow the device 100 to be operated in the manner described herein. The arm 140 may further be positioned in any arrangement, orientation, configuration, etc. 100 to allow the device 100 to be operated in the manner described herein.

The walls 128,138 may be further connected via at least one connecting member 150. The member 150 provides support for the walls 128,138 when spaced apart and may be adjustable such that it can increase and decrease in length/width as the walls 128,138 are spaced apart.

The frame 110 may also be comprised of at least one wheel 112 that allows the device 100 to be rolled as desired.

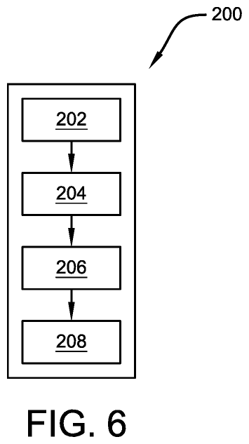

The present invention is also comprised of a method of using 200 the device 100, as seen in FIG. 6. First, a device 100 is provided comprised of a frame 110, a first fork 120 that attaches over the frame 110, a second fork 130 that attaches over the frame 110, a first rear wall 128 that attaches to the first fork 120, and a second rear wall 138 that attaches to the second fork 130 [Step 202]. Then, the distance between the forks 120,130 can be increased or decreased via at least one arm 140 [Step 204]. Next, the distance between each fork 120,130 and each rear wall 128,138 can be increased or decreased via at least one arm 140 [Step 206]. Then, a pallet (or other item) can be placed on the forks 120,130 and can be supported by the rear walls 128,138 while the device 100 is used to transport the pallet along a surface [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “expandable pallet jack device” and “device” are interchangeable and refer to the expandable pallet jack device 100 of the present invention.

Notwithstanding the forgoing, the expandable pallet jack device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the expandable pallet jack device 100 as shown in the FIGS. are for illustrative purposes only, and that many other sizes and shapes of the expandable pallet jack device 100 are well within the scope of the present disclosure. Although the dimensions of the expandable pallet jack device 100 are important design parameters for user convenience, the expandable pallet jack device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An expandable pallet jack device comprising:
a frame comprised of a first wheel;
a first fork;
a second fork; and
an arm connecting the first fork to the second fork.

2. The expandable pallet jack device of claim 1, wherein the arm is comprised of a hydraulic arm, an electronic arm, or a motored arm.

3. The expandable pallet jack device of claim 1, wherein the first fork and the second fork movably attach to the frame.

4. The expandable pallet jack device of claim 1, wherein a first top surface of the first fork and a second top surface of the second fork are comprised of a texture.

5. The expandable pallet jack device of claim 4, wherein the texture is comprised of a raised texture.

6. The expandable pallet jack device of claim 2, wherein the arm can be decreased or increased in length via a handle.

7. The expandable pallet jack device of claim 2, wherein the arm can be decreased or increase in length via a foot lever.

8. An expandable pallet jack device comprising:
a frame comprised of a first wheel;
a first fork comprised of a first rear wall;
a second fork comprised of a second rear wall;
a first arm connecting the first fork to the second fork; and
a second arm connecting the first rear wall to the second rear wall.

9. The expandable pallet jack device of claim 8, wherein the first arm is comprised of a hydraulic arm, an electronic arm, or a motored arm.

10. The expandable pallet jack device of claim 8, wherein the second arm is comprised of a hydraulic arm, an electronic arm, or a motored arm.

11. The expandable pallet jack device of claim 8, wherein the first fork and the second fork movably attach to the frame.

12. The expandable pallet jack device of claim 8, wherein the first arm and the second arm can be decreased or increased in length via a handle.

13. The expandable pallet jack device of claim 8, wherein the first arm and the second arm can be decreased or increased in length via a foot lever.

14. The expandable pallet jack device of claim 8 further comprised of a connecting member.

15. The expandable pallet jack device of claim 14, wherein the connecting member attaches to the first rear wall and the second rear wall.

16. The expandable pallet jack device of claim 8, wherein the first fork is comprised of a first roller.

17. The expandable pallet jack device of claim 8, wherein the second fork is comprised of a second roller.

18. A method of using an expandable pallet jack device, the method comprising the following steps:
providing an expandable pallet jack device comprised of a frame, a first fork that attaches over the frame, a second fork that attaches over the frame, a first rear wall that attaches to the first fork, and a second rear wall that attaches to the second fork;
increasing or decreasing a distance between the first fork and the second fork;
increasing or decreasing a distance between the first fork and the first rear wall;
increasing or decreasing a distance between the second fork and second first rear wall; and
placing an item on the forks.

19. The method of using an expandable pallet jack device of claim 18, wherein the item is comprised of a pallet.

20. The method of using an expandable pallet jack device of claim 18 further comprised of an arm that connects the first fork to the second fork.
